(19) United States
(12) Patent Application Publication
(10) Pub. No.: US 2015/0145852 A1
(43) Pub. Date: May 28, 2015

(54) DISPLAY DEVICE

(71) Applicant: Samsung Display Co., Ltd., Yongin-City (KR)

(72) Inventors: Ik Hyun Ahn, Hwaseong-si (KR); Yoongu Kim, Garak-dong (KR); Bongim Park, Asan-si (KR); Hoseok Son, Anyang-si (KR)

(21) Appl. No.: 14/332,227

(22) Filed: Jul. 15, 2014

(30) Foreign Application Priority Data
Nov. 26, 2013 (KR) 10-2013-0144708

(51) Int. Cl. G09G 3/36

(52) U.S. Cl. CPC G09G 3/3688; G09G 3/3648; G09G 2300/0426; G09G 2310/08; G09G 2320/02
USPC 345/214; 345/99

(57) ABSTRACT

A display device with a timing controller is disclosed. In one aspect the display includes first and second gate drivers, first and second gate lines extending in first and second directions from the first and second gate drivers, data lines extending in a third direction, a display panel including pixels connected to the first and second gate lines and the data lines, data driving circuits each driving corresponding data lines in response to an output start signal and a data signal, and a timing controller. The timing controller sets an output timing of the data signals according to a distance in the first direction between the first gate driver and the data driving circuits when the first gate lines are driven and sets an output timing of the data signals according to a distance in the second direction between the second gate driver and the data driving circuits when the second gate lines are driven.

### CROSS-REFERENCE TO RELATED APPLICATIONS

This application claims priority under 35 U.S.C. §119 to Korean Patent Application No. 10-2013-0144708 filed on Nov. 26, 2013, the disclosure of which is incorporated by reference herein in its entirety.

### BACKGROUND

1. Field

The described technology generally relates to a display device, particularly, to a display device having improved display quality.

2. Description of the Related Technology

In general, a display device includes a display panel to display an image and data and gate drivers to drive the display panel. The display panel includes gate lines, data lines, and pixels. Each pixel includes a thin film transistor, a liquid crystal capacitor, and a storage capacitor. The data driver applies data driving signals to the data lines and the gate driver applies gate driving signals to the gate driver.

The display device applies a gate-on voltage to a gate electrode of the thin film transistor through a corresponding gate line of the gate lines and applies a data voltage corresponding to the image to a source electrode of the thin film transistor through a corresponding data line of the data lines, and thus a desired image is obtained. The data voltage, which is charged in the liquid crystal capacitor and the storage capacitor while the thin film transistor is turned on, is required to be maintained for a predetermined time after the thin film transistor is turned off.

### SUMMARY OF CERTAIN INVENTIVE ASPECTS

One inventive aspect is a display device capable of preventing display quality deterioration regardless of the increase in size of the display device.

Another aspect is a display device capable of implementing a narrow bezel.

Another aspect is a display device including a first gate driver, a second gate driver, a plurality of first gate lines extending in a first direction from the first gate driver, a plurality second gate lines extending in a second direction from the second gate driver, a plurality of data lines extending in a third direction substantially perpendicular to the first and second directions, a display panel including a plurality of pixels electrically connected to the first and second gate lines and the data lines, a plurality of data driving circuits each configured to drive corresponding data lines among the data lines in response to an output start signal and a data signal, and a timing controller configured to apply the output start signal and the data signal to the data driving circuits and control the first and second gate drivers. The timing controller is further configured to set an output timing of the data signal applied to each of the data driving circuits in accordance with a distance in the first direction between the first gate driver and the data driving circuits when the first gate lines are driven and to set a second output timing of the data signals applied to each of the data driving circuits in accordance with a distance in the second direction between the second gate driver and the data driving circuits when the second gate lines are driven.

In example embodiments, the timing controller is further configured to increase a delay time of the output timing of the data signal applied to each of the data driving circuits as the distance in the first direction between the first gate driver and the data driving circuits becomes longer when the first gate lines are driven.

In example embodiments, the timing controller is further configured to increase a delay time of the second output timing of the data signal applied to each of the data driving circuits as the distance in the second direction between the second gate driver and the data driving circuits becomes longer when the second gate lines are driven.

In example embodiments, the first direction and the second direction are opposite to each other.

In example embodiments, the data lines are grouped into a plurality of data lines groups and the data driving circuits correspond to the data line groups.

In example embodiments, the first gate driver is configured to sequentially apply first gate signals to the first gate lines and the second gate driver is configured to sequentially apply second gate signals to the second gate lines.

In example embodiments, the timing controller is configured to delay the first output timing of the data signal applied to each of the data driving circuits sequentially in the first direction by a time corresponding to the delay time in the first direction of the first gate signals applied to the first gate lines.

In example embodiments, the timing controller is configured to delay the second output timing of the data signal applied to each of the data driving circuits sequentially in the second direction by a time corresponding to the delay time in the second direction of the second gate signals applied to the second gate lines.

In example embodiments, the timing controller is further configured to compensate for the data signal when the first lines are driven; wherein the data signal compensation is in accordance with a distance in the first direction between the first gate driver and a position of the display panel at which the data signal is displayed.

In example embodiments, the timing controller is further configured to compensate for the data signal when the second gate lines are driven; wherein the data signal compensation is in accordance with a distance in the second direction between the second gate driver and a position of the display panel at which the data signal is displayed.

In example embodiments, the timing controller is further configured to compensate for the data signal in accordance with a distance in the third direction between the data driving circuits and a position of the display panel at which the data signal is displayed.

In example embodiments, the timing controller is further configured to increase a compensation amount of the data signal as the distance in the third direction between the data driving circuits and a position of the display panel at which the data signal is displayed, increases.

In example embodiments, the first gate driver is placed adjacent to a first end of the display panel and the second gate driver is placed adjacent to a second end of the display panel.

In example embodiments, the data driving circuits are sequentially arranged in the first direction to be adjacent to a long side of the display panel.

In example embodiments, the first gate lines and the second gate lines are alternately arranged one by one.

Another aspect is a display device including a first gate driver; a plurality of first gate lines extending in a first direction from the first gate driver; a plurality of data lines extending in a third direction substantially perpendicular to the first direction; a display panel including a plurality of pixels electrically connected to the first gate lines and the data lines; a plurality of data driving circuits each configured to drive corresponding data lines among the data lines in response to an output start signal and a data signal; and a timing controller configured to apply the output start signal and the data signal to the data driving circuits and control the first gate drivers, wherein the timing controller is further configured to set a first output timing of the data signal applied to each of the data driving circuits in accordance with a distance in the first direction between the first gate driver and the data driving circuits when the first gate lines are driven.

With embodiments of the inventive concept, the output timing of the data signal output from the timing controller may be controlled in accordance with the distance between the gate driver and the data lines. Thus, the display quality of the display device may be improved.

### BRIEF DESCRIPTION OF THE DRAWINGS

FIG. 1 is a plan view illustrating a display device according to an exemplary embodiment.

FIG. 2 is a block diagram illustrating the display device shown in FIG. 1.

FIG. 3 is a block diagram illustrating the first gate driver shown in FIG. 2.

FIG. 4 is a block diagram illustrating the second gate driver shown in FIG. 2.

FIGS. 5 and 6 are waveform diagrams illustrating a gate signal applied to the first gate line of the gate lines shown in FIG. 1 and a data driving signal.

FIG. 7 is a timing diagram illustrating data signals and output start signals, applied to the data driver integrated circuits from a timing controller shown in FIG. 1.

FIG. 8 is a timing diagram illustrating data signals and output start signals, applied to the data driver integrated circuits from a timing controller shown in FIG. 1.

FIG. 9 is a view illustrating a method of setting an output timing of a data signal in accordance with a delay of the gate signal.

FIG. 10 is a view illustrating a method of setting an output timing of a data signal in accordance with a delay of the gate signal passing through other gate lines.

FIG. 11 is a view illustrating an image displayed in the display panel shown in FIG. 1.

FIG. 12 is a view illustrating an example of compensating a data driving signal applied to the display panel shown in FIG. 11.

FIG. 13 is a view illustrating another example of compensating a data driving signal applied to the display panel shown in FIG. 11.

### DETAILED DESCRIPTION OF CERTAIN INVENTIVE EMBODIMENTS

In recent years, demand for display devices with large screens and high driving speed has increased, and thus, signal delays that occur in gate lines reduce image quality. It is also problematic that the charge rate of the liquid crystal capacitors located relatively far away from the gate driver is lower than that of the liquid crystal capacitors located relatively close to the gate driver.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments will now be described more fully hereinafter with reference to the accompanying drawings. However, the described embodiments may be embodied in different forms and should not be construed as limited to the embodiments set forth herein. Rather, these embodiments are provided so that this disclosure will be thorough and complete and will fully convey the scope of the described technology to those skilled in the art.

In the figures, dimensions may be exaggerated for clarity of illustration. It will be understood that when an element is referred to as being “between” two elements, it can be the only element between the two elements, or one or more intervening elements may also be present.

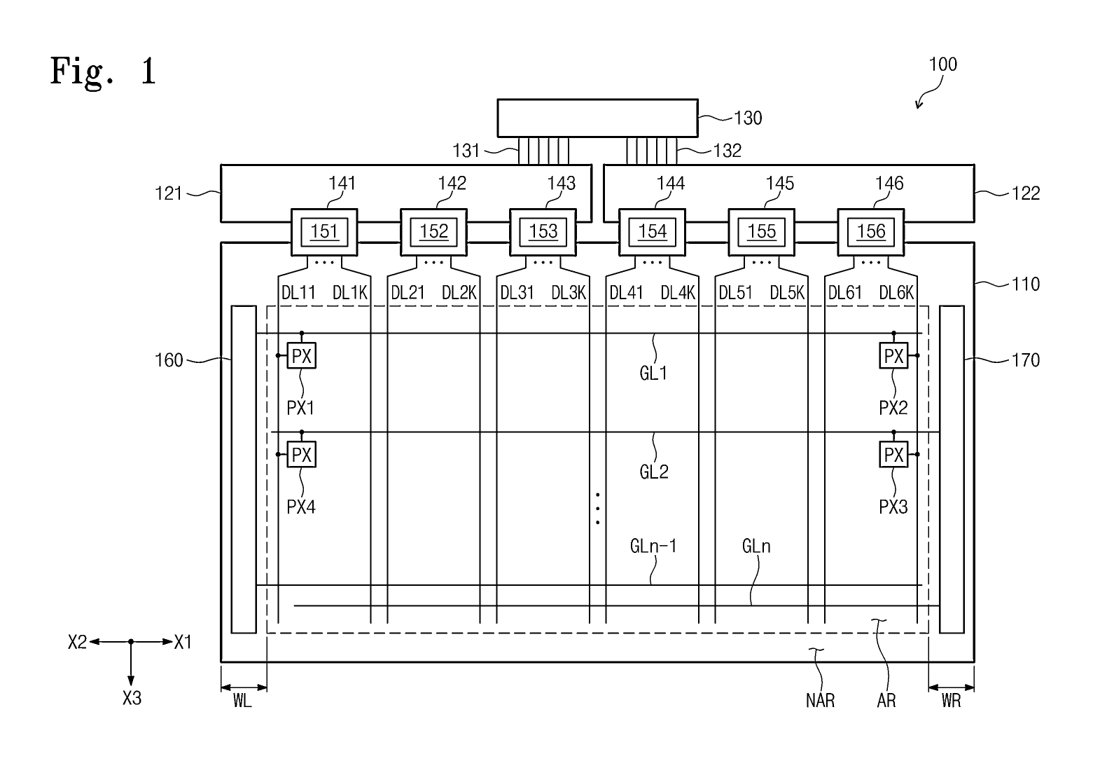

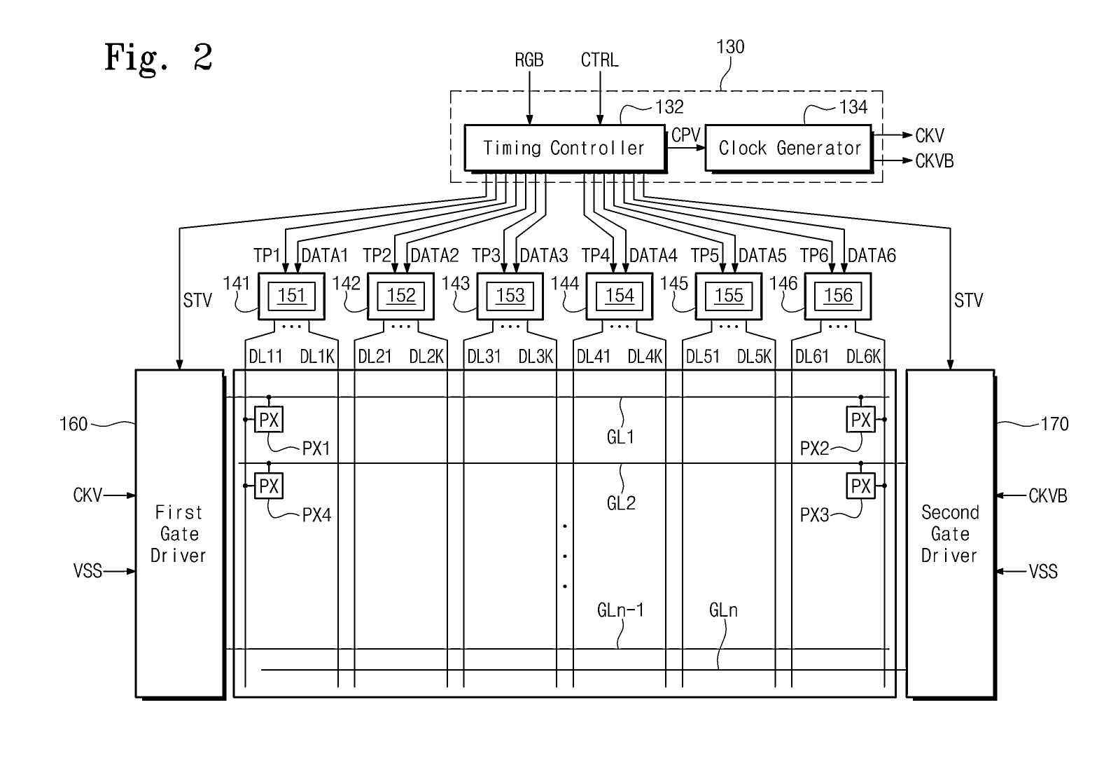

FIG. 1 is a plan view showing a display device according to an exemplary embodiment of the present disclosure and FIG. 2 is a block diagram showing the display device shown in FIG. 1.

Referring to FIGS. 1 and 2, a display device 100 includes a display panel 110, printed circuit boards 121 and 122, a control board 130, data driving circuits 141 to 146, and first and second gate drivers 160 and 170. The number of circuit boards, control board, and driving circuits in the drawings are exemplary. Persons of ordinary skill in the art can envision more components or fewer components without departing from the disclosure of this application.

The display panel 110 includes a display area AR in which a plurality of pixels PX are arranged and a non-display area NAR formed adjacent to the display area AR. The display area AR displays an image and the non-display area NAR does not display any image. The display panel 110 may be a glass substrate, a silicon substrate, or a film substrate. Other materials can also be used.

The printed circuit boards 121 and 122 include a control board 130 and a plurality of lines connected to the first and second gate drivers 160 and 170 and the data driving circuits 141 to 146.

The control board 130 is electrically connected to the printed circuit boards 121 and 122 through cables 131 and 133, respectively. The control board 130 includes a timing controller 132 and a clock generator 134.

The timing controller 132 applies data signals DATA1 to DATA6 and output start signals TP1 to TP6 to the data driving circuits 141 to 146 through the cables 131 and 133. The timing controller 132 also applies a vertical start signal STV to the first and second gate drivers 160 and 170. The timing controller 132 further applies a horizontal synchronization start signal and a line latch signal to the data driving circuits 141 to 146. The timing controller 132 further applies an output-enable signal to the first and second gate drivers 160 and 170. The timing controller 132 applies a gate pulse signal CPV to the clock generator 134.

The clock generator 134 outputs a first gate clock signal CKV and a second gate clock signal CKVB in response to the gate pulse signal CPV. The first gate clock signal CKV is applied to the first gate driver 160 and the second gate clock signal CKVB is applied to the second gate driver 170. The first gate clock signal CKV and the second gate clock signal CKVB are complementary to each other.

The data driving circuits 141 to 146 can be implemented for example by a tape carrier package (TCP) or a chip-on-film (COF). Other implementations can also be used. The data driver integrated circuits 151 to 156 are respectively mounted on the data driving circuits 141 to 146. Each of the data driving circuits 151 to 156 drives the data lines in response to a corresponding data signal of the data signals DATA1 to DATA6 and a corresponding output start signal of the output start signals TP1 to TP6. The data driver integrated circuits 151 to 156 may be directly mounted on the display panel 110 without being placed on the printed circuit boards 121 and 122.

Each of the data driving circuits 141 to 146 drives corresponding K data lines of the data lines DL11 to DL6K using data driving signals, where K is a positive integer number. In the present exemplary embodiment, each of the data driver integrated circuits 151 to 156 may change an output timing of the data driving signal applied to the data lines DL1 to DL6K in response to the output start signals TP1 to TP6 provided from the timing controller 132. The data lines DL11 to DL6K extend in a third direction X3 from the data driver integrated circuits 151 to 156.

The data driving circuits 141 to 146 are sequentially arranged in a first direction X1 and placed adjacent to a first long side of the display panel 110. The first gate driver 160 is placed adjacent to a first short side of the display panel 110 and the second gate driver 170 is placed adjacent to a second short side of the display panel 110.

The first and second gate drivers 160 and 170 are configured in a circuit using amorphous silicon gate thin film transistor (a-Si TFT), oxide semiconductor, crystalline semiconductor, or polycrystalline semiconductor and integrated in the non-display area NAR of the display panel 110. According to another embodiment, the first and second gate drivers 160 and 170 may be respectively attached to the first and second short sides of the display panel 110 in the TCP or COF form. Other methods of attachment can also be used.

The first gate driver 160 drives a first group of gate lines GL1 to GLn−1 (hereinafter, referred to as the first gate line group) in response to the vertical start signal STV from the timing controller 132 and the first gate clock signal CKV from the clock generator 134. The first gate line group GL1 to GLn−1 extends in the first direction X1 from the first gate driver 160. The first gate line group GL1 to GLn−1 includes odd-numbered gate lines of the gate lines GL1 to GLn.

The second gate driver 170 drives a second group of gate lines GL2 to GLn (hereinafter, referred to as the second gate line group) in response to the vertical start signal STV from the timing controller 132 and the second gate clock signal CKVB from the clock generator 134. The second gate line group GL2 to GLn extends in the second direction X2 from the first gate driver 170. The first direction X1 and the second direction X2 are opposite each other. The second gate line group GL2 to GLn includes even-numbered gate lines of the gate lines GL1 to GLn.

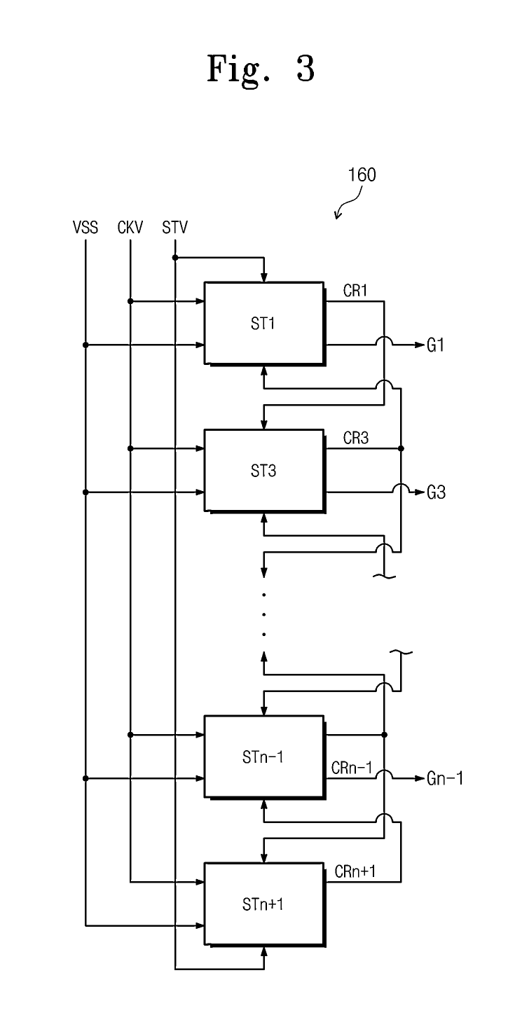

FIG. 3 is a block diagram showing the first gate driver shown in FIG. 2.

Referring to FIG. 3, the first gate driver 160 includes a plurality of stages ST1 to STn−1 and a dummy stage STn+1. The stages ST1 to STn−1 respectively correspond to first gate lines GL1 to GLn−1 that are odd-numbered gate lines. A first stage ST1 of the stages ST1 to STn−1 receives a start pulse signal STV, the gate clock signal CKV, a ground voltage VSS, and a next carry signal CR3 from a next stage and outputs a carry signal CR1 and a gate signal G1. The gate signal G1 is applied to the gate line GL1 shown in FIG. 2.

Each stage STi (i=3, 5, . . . , n−1) of the stages ST1 to STn−1 except for the first stage ST1 receives a previous carry signal CRi−2 from a previous stage, the gate clock signal CKV, the ground voltage VSS, and a next carry signal CRi+2 and outputs a carry signal CRi and a gate signal Gi. The gate signal Gi is applied to the gate line GLi shown in FIG. 2.

The dummy stage STn+1 receives a previous carry signal CRn−1, the gate clock signal CKV, the ground voltage VSS, and the start pulse signal STV and outputs a carry signal CRn+1 and a gate signal GDn+1 (not shown).

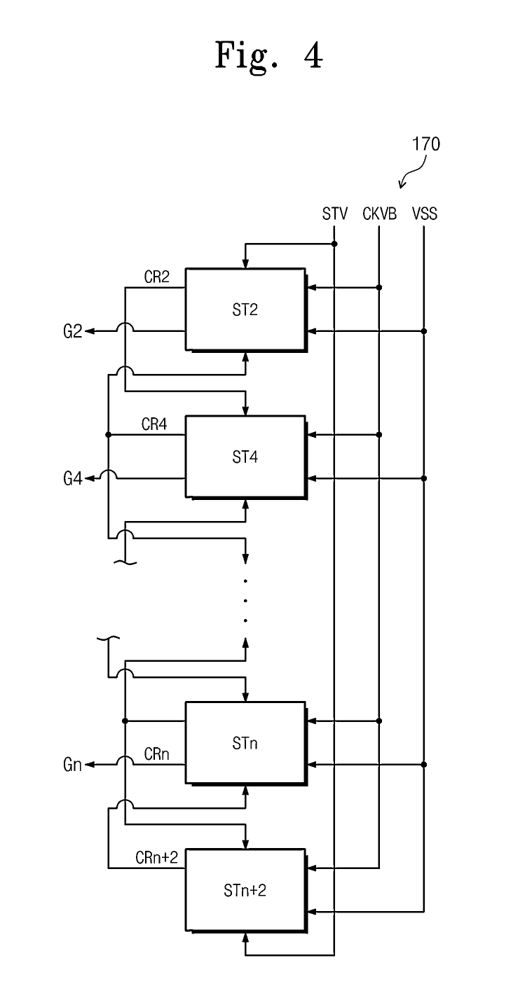

FIG. 4 is a block diagram showing the second gate driver shown in FIG. 2.

Referring to FIG. 4, the second driver 170 includes a plurality of stages ST2 to STn and a dummy stage STn+2. The stages ST2 to STn respectively correspond to the second gate lines GL2 to GLn that are even-numbered gate lines. A first stage ST2 of the stages ST2 to STn receives a start pulse signal STV, the gate clock bar signal CKVB, a ground voltage VSS, and a next carry signal CR4 from a next stage and outputs a carry signal CR2 and a gate signal G2. The gate signal G2 is applied to the gate line GL2 shown in FIG. 2.

Each stage STj+1 (j=1, 3, 5, . . . , n−1) of the stages ST2 to STn except for the first stage ST2 receives a previous carry signal CRj−1 from a previous stage, the gate clock signal CKV, the ground voltage VSS, and a next carry signal CRj+3 and outputs a carry signal CRj+1 and a gate signal Gj+1. The gate signal Gj+1 is applied to the gate line GLj shown in FIG. 2.

The dummy stage STn+2 receives a previous carry signal CRn, the gate clock signal CKVB, the ground voltage VSS, and the start pulse signal STV and outputs a carry signal CRn+2.

The first gate driver 160 includes the stages ST1 to STn−1 and the dummy stage STn+1 to drive the first gate line group GL1 to GLn−1 and the second gate driver 170 includes the stages ST2 to STn and the dummy stage STn+2 to drive the second gate line group GL2 to GLn.

When the stages ST1 to STn−1 and the dummy stage STn+1, which are shown in FIG. 3, and the stages ST2 to STn and the dummy stage STn+2, which are shown in FIG. 3, are both placed at an edge of the display panel 110, it is difficult to implement a narrow bezel for the display panel 110.

As shown in FIG. 1, the first gate driver 160 including the stages ST1 to STn−1 and the dummy stage STn+1 is placed at the first edge of the display panel 110 and the second gate driver 170 including the stages ST2 to STn and the dummy stage STn+2 is placed at the second edge of the display panel 110. Since both gate drivers 160 and 170 are not implemented on a single edge of the display panel 110, a width WL of the non-display area NAR at the first edge of the display panel 110 and a width WR of the non-display area NAR at the second edge of the display panel 110 may be reduced. Thus, a narrow bezel for the display device 100 may be easily implemented.

The first gate line group GL1 to GLn−1 and the second gate line group GL2 to GLn are alternately arranged in the third direction X3 one by one. The third direction X3 is substantially vertical to the first and second directions X1 and X2. In the present exemplary embodiment, the first gate line group GL1 to GLn−1 includes the odd-numbered gate lines and the second gate line group GL2 to GLn includes the even-numbered gate lines.

When a gate-on signal is applied to a gate line, switching transistors connected to that gate line and arranged in the same row are turned on. The data driver integrated circuits 151 to 156 apply the data driving signals corresponding to data signals DATA to the data lines DL11 to DL6K. The data driving signals applied to the data lines DL11 to DL6K are applied to the corresponding pixels through turned-on switching transistors.

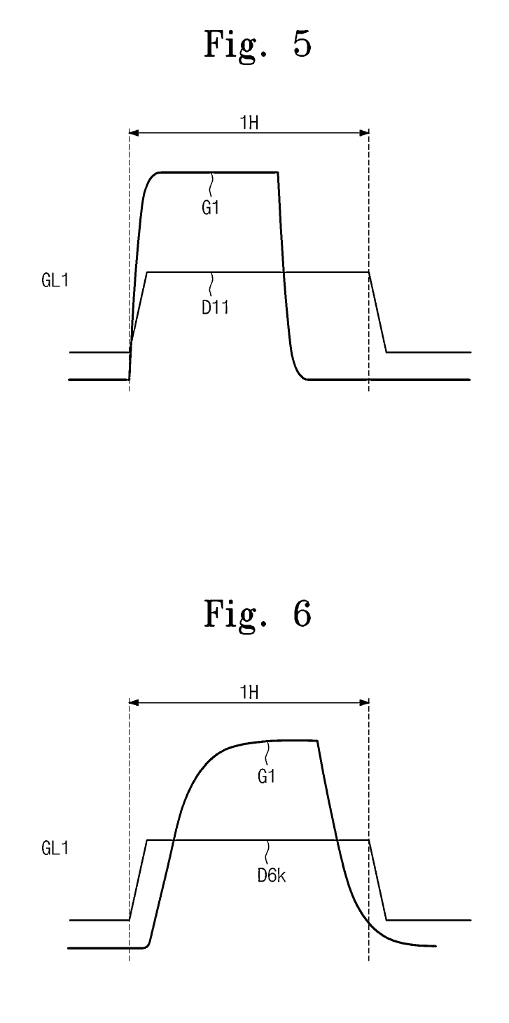

FIGS. 5 and 6 are waveform diagrams showing a gate signal applied to the first gate line of the first group of gate lines shown in FIG. 1 and a data driving signal. FIG. 5 shows a data driving signal applied to the data line placed adjacent to the gate driver and the gate signal. FIG. 6 shows a data driving signal applied to the data line placed far away from the gate driver and the gate signal.

Referring to FIGS. 5 and 6, the first gate signal G1 generated by the first gate driver 160 of FIG. 1 is transferred through the gate line GL1. A first pixel PX1 is connected to the gate line GL1 and the data line DL11 and a second pixel PX2 is connected to the gate line GL1 and the data line DL6K. The first gate signal G1 output from the first gate driver 160 may be delayed by a predetermined time while being applied to the second pixel PX2 formed far away from the first gate driver 160 in the first direction X1.

For the gate signal G1, a period in which the switching transistors arranged in its row are turned on, is called “one horizontal period” or “1H.” The charge rate of the second pixel PX2 is lowered when the turn-on time of the switching transistor of the second pixel PX2 is shortened due to the delay of the gate signal G1.

That is, although the data driver integrated circuits 151 to 156 apply the data driving signals D11 to D6K to the data lines DL11 to DL6K at the same time, the charge rate of the second pixel PX2, formed relatively far away from the first gate driver 160 in the first direction X1 than the first pixel PX1 formed adjacent to the first gate driver 160 in the first direction X1, is lowered.

Similarly, due to the delay of the gate signal G2 applied to the gate line GL2, a charge rate of the fourth pixel PX4, which is formed relatively far away from the second gate driver 170 of FIG. 1 in the second direction X2 than the third pixel PX3 formed adjacent to the second gate driver 170 in the second direction X2, is lowered.

Hereinafter, a method of delaying the data driving signals D11 to D6K applied to the data lines DL11 to DL6K by the delay time of the gate signals G1 to Gn will be described in detail in order to compensate for the delay of the gate signals G1 to Gn transferred through the gate lines GL1 to GLn.

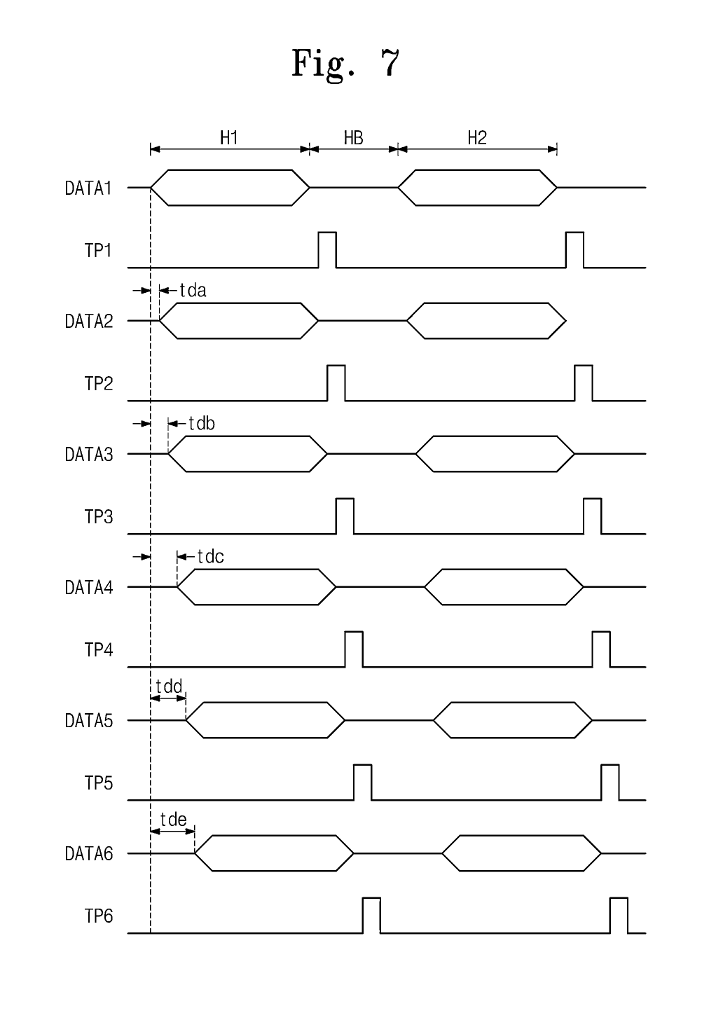

FIG. 7 is a timing diagram showing data signals and output start signals, applied to the data driver integrated circuits from the timing controller shown in FIG. 1.

Referring to FIGS. 2 and 7, the timing controller 132 applies the data signals DATA1 to DATA6 and the output start signals TP1 to TP6 in parallel to the data driving circuits 141 to 146. That is, the timing controller 132 applies the data signal DATA1 and the output start signal TP1 to the data driving circuit 141 and applies the data signal DATA2 and the output start signal TP2 to the data driving circuit 142 and so forth.

When the first gate driver 160 drives the first gate line group GL1 to GLn−1, the timing controller 132 outputs the data signal DATA2 to the data driving circuit 142 after a predetermined delay time tda lapses from the time point at which the timing controller 132 outputs the data signal DATA1 to the data driving circuit 141. Similarly, the timing controller 132 outputs the data signal DATA3 to the data driving circuit 143 after a predetermined delay time tdb lapses from the time point at which the timing controller 132 outputs the data signal DATA1 to the data driving circuit 141. As described above, the output timings of the data signals DATA1 to DATA6 applied to the data driving circuits 141 to 146 are set to be different from each other, and thus the delay of the gate signals G1 to Gn transferred through the gate lines GL1 to GLn−1 may be compensated.

That is, the timing controller 132 delays the output timing of the data signals DATA1 to DATA6 applied to the data driving circuits 141 to 146 in accordance with the distance in the first direction X1 between the first gate driver 160 and the data driving circuits 141 to 146 while the first gate driver 160 drives the first gate line group GL1 to GLn−1.

In some embodiments, as the data driving circuits 141 to 146 are placed far away from the first gate driver 160 in the first direction X1, the delay time of the gate signals G1 to Gn−1 becomes longer. Accordingly, when the output timing of the data signals DATA1 to DATA6 is also gradually delayed, the charge rate in the pixels are not lowered.

According to another embodiment, the timing controller 132 substantially simultaneously outputs the data signals DATA1 to DATA6, but sequentially delays the output of the output start signals TP1 to TP6. In general, a horizontal blank period HB between a data signal transmission period H1 for an i-th horizontal line of the display panel 110 and a data signal transmission period H2 for an (i+1)th horizontal line of the display panel 110 is very short. In the case that the timing controller 132 substantially simultaneously outputs the data signals DATA1 to DATA6 and sequentially delays the output of the output start signals TP1 to TP6, the delay time range of each of the output start signals TP1 to TP6 is limited.

As shown in FIG. 7, the method of delaying the output timing in each of the data signals DATA1 to DATA6 may be performed by setting the output timing of each of the data signals DATA1 to DATA6 regardless of the length of the horizontal blank period HB.

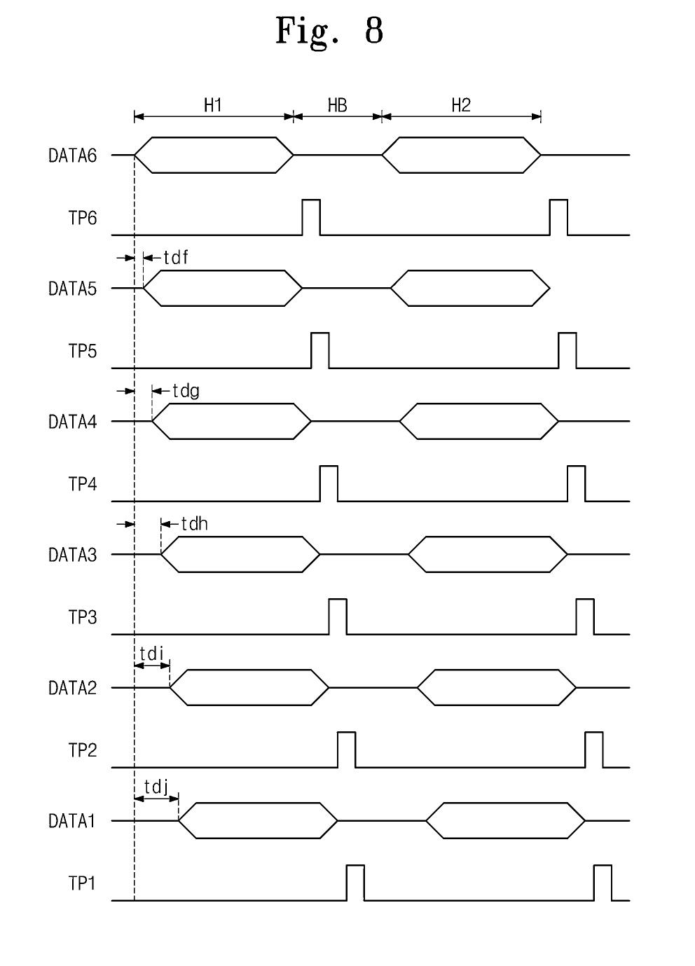

FIG. 8 is a timing diagram showing data signals and output start signals, which are applied to the data driver integrated circuits from the timing controller shown in FIG. 1.

Referring to FIGS. 2 and 8, the timing controller 132 applies the data signals DATA1 to DATA6 and the output start signals TP1 to TP6 in parallel to the data driving circuits 141 to 146. That is, the timing controller 132 applies the data signal DATA1 and the output start signal TP1 to the data driving circuit 141 and applies the data signal DATA2 and the output start signal TP2 to the data driving circuit 142 and so forth.

When the second gate driver 170 drives the second gate line group GL2 to GLn, the timing controller 132 outputs the data signal DATA5 to the data driving circuit 145 after a predetermined delay time tdf lapses from the time at which the timing controller 132 outputs the data signal DATA6 to the data driving circuit 146. Similarly, the timing controller 132 outputs the data signal DATA4 to the data driving circuit 144 after a predetermined delay time tdg lapses from the time at which the timing controller 132 outputs the data signal DATA5 to the data driving circuit 145. As described above, the output timings of the data signals DATA6 to DATA1 applied to the data driving circuits 146 to 141 are set to be different from each other, and thus the delay of the gate signals G2 to Gn transferred through the gate lines GL2 to GLn may be compensated.

That is, the timing controller 132 delays the output timing of the data signals DATA6 to DATA1 applied to the data driving circuits 146 to 141 in accordance with the distance in the second direction X2 between the second gate driver 170 and the data driving circuits 146 to 141 while the second gate driver 170 drives the second gate line group GL2 to GLn.

As described in FIG. 7, the timing controller 132 delays the data signals DATA1 to DATA6 by the predetermined delay times tda, tdb, tdc, tdd, and tde, respectively, and sequentially outputs the data signals DATA1 to DATA6 while the first gate driver 160 drives the first group of gate lines GL1 to GLn−1.

As described in FIG. 8, the timing controller 132 delays the data signals DATA6 to DATA1 by the predetermined delay times tdf, tdg, tdh, tdi, and tdj, respectively, and sequentially outputs the data signals DATA6 to DATA1 while the second gate driver 170 drives the second group of gate lines GL2 to GLn.

As described above, the output order and the delay time of the data signals DATA1 to DATA6 are set according to the transfer direction of the gate signals G1 to Gn through the gate lines GL1 to GLn, and thus the delay of the gate signals G1 to Gn transferred through the gate lines GL1 to GLn may be compensated.

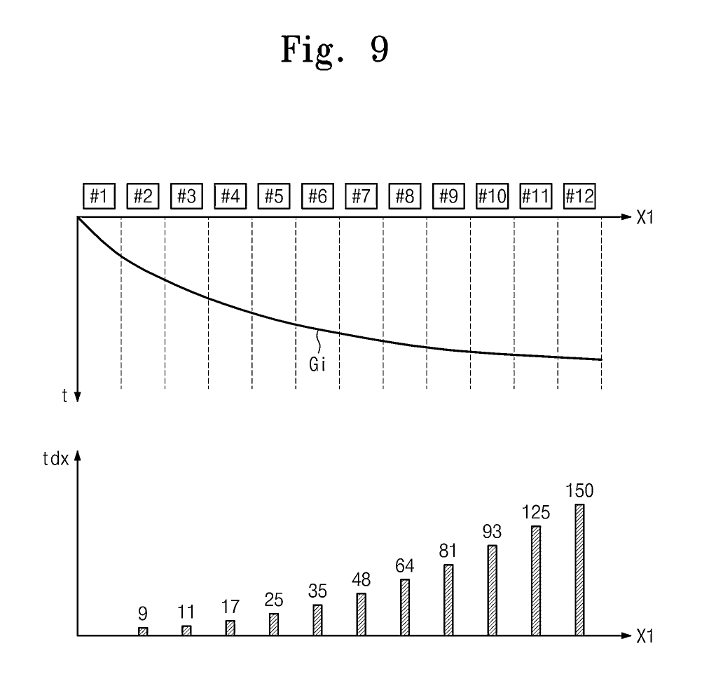

FIG. 9 is a view showing a method of setting the output timings of the data signals in accordance with the delay of the gate signals passing through the first gate line group.

Referring to FIGS. 2 and 9, when the number of the data driving circuits arranged on the display device 100 is twelve, the timing controller 132 sets the output timings of the data signals DATA1 to DATA12 to be different from each other in each data driving circuit #1 to #12.

As shown in FIG. 9, the delay time of the gate signals Gi (i=1, 3, . . . , n−1) is increased as the gate line extends further from the first gate driver 160 while the first gate driver 160 drives the first gate line group GL1 to GLn−1.

In order to compensate for the delay time of the gate signal Gi, the output timings of the data signals DATA1 to DATA12, applied to the data driving circuits #1 to #12, are set to be different from each other. The timing controller 132 delays the output timings of the data signals DATA1 to DATA12 applied to the data driving circuits #1 to #12 on the basis of the delay time of the gate signal Gi outputted from the first gate driver 160.

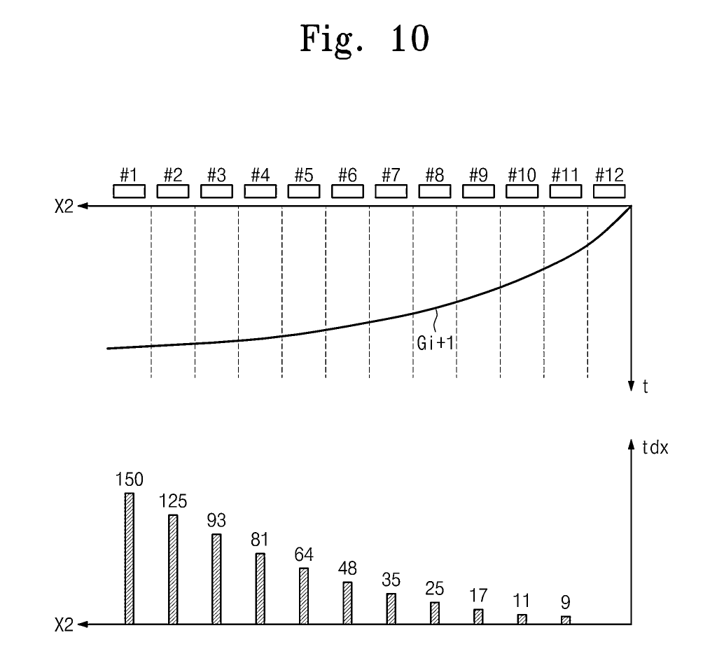

FIG. 10 is a view showing a method of setting the output timings of the data signals in accordance with the delay of the gate signals passing through the second gate line group.

Referring to FIGS. 2 and 10, when the number of the data driving circuits arranged on the display device 100 is twelve, the timing controller 132 sets the output timings of the data signals DATA1 to DATA12 to be different from each other in each data driving circuit #1 to #12.

As shown in FIG. 10, the delay time of the gate signals Gj (j=2, 4, . . . , n) increases as the gate line extends further away from the second gate driver 170 while the second gate driver 170 drives the second gate line group GL2 to GLn.

Therefore, the output timings of the data signals DATA1 to DATA12, applied to the data driving circuits #1 to #12 in order to compensate for the delay time of the gate signals Gj, are set to be different from each other. The timing controller 132 delays the output timings of the data signals DATA1 to DATA12 applied to the data driving circuits #1 to #12 on the basis of the delay time of the gate signals Gj output from the second gate driver 170.

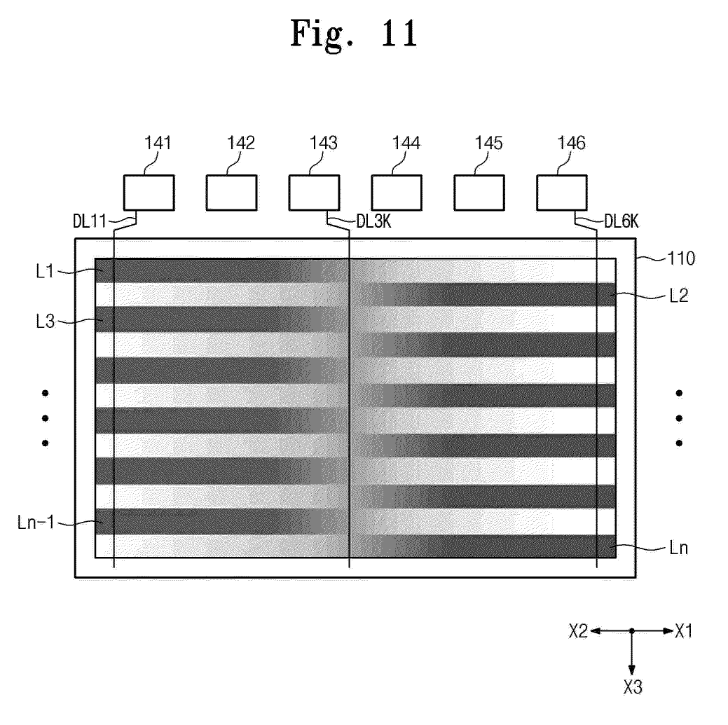

FIG. 11 is a view showing an image displayed in the display panel shown in FIG. 1.

Referring to FIGS. 2 and 11, although the data driving signals having the same gray scale are applied to the data lines DL1 to DL6K when the first gate driver 160 drives the first gate line group GL1 to GLn−1, the charge rate of the pixels formed relatively far away from the first gate driver 160 may be lower than the charge rate of the pixels formed adjacent to the first gate driver 160. In this case, the brightness at a position corresponding to the data line DL6K is lower than the brightness at a position corresponding to the data line DL11 in odd-numbered horizontal lines L1 to Ln−1 of the display panel 110, which correspond to the first group of gate lines GL1 to GLn−1.

Similarly, although the data driving signals having the same gray scale are applied to the data lines DL1 to DL6K when the second gate driver 170 drives the second gate line group GL2 to GLn, the charge rate of the pixels formed relatively far away from the second gate driver 170 may be lower than the charge rate of the pixels formed adjacent to the second gate driver 170. In this case, the brightness at a position corresponding to the data line DL11 is lower than the brightness at a position corresponding to the data line DL6K in even-numbered horizontal lines L2 to Ln of the display panel 110, which correspond to the second group of gate lines GL2 to GLn.

Due to the charge rate between the pixels PX of the display panel 110, horizontal line patterns may appear in the horizontal lines L1 to Ln of the display panel 110 corresponding to the gate lines GL1 to GLn.

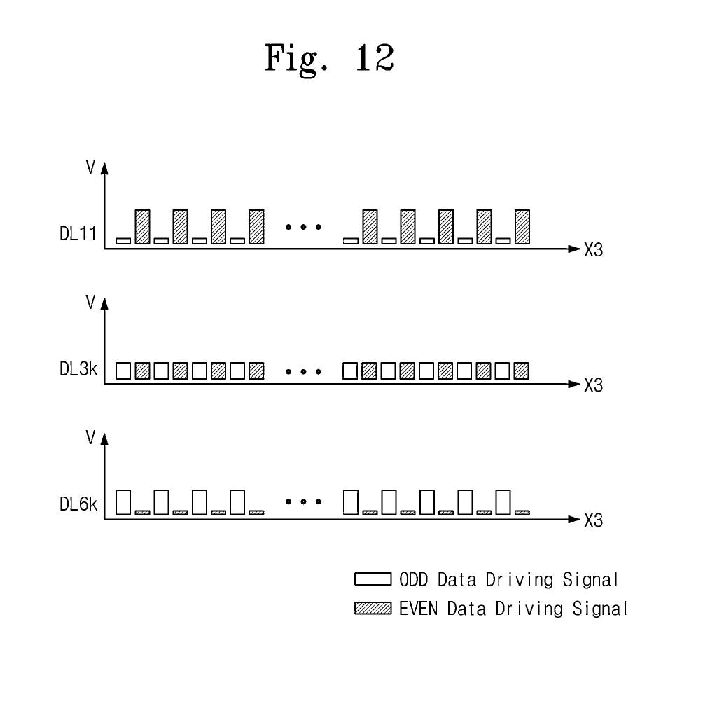

FIG. 12 is a view showing an example of compensating the data driving signals applied to the display panel shown in FIG. 11.

Referring to FIGS. 2 and 12, when the first gate driver 160 drives the first gate line group GL1 to GLn−1, the timing controller 132 controls and outputs the data signals DATA1 to DATA6 such that a gray scale voltage level of the data driving signal applied to the data driving circuit 146 placed far away from the first gate driver 160 becomes higher than that of the data driving signal applied to the data driving circuit 141 placed adjacent to the first gate driver 160 with respect to the same image RGB signals. In FIG. 12, the data driving signal applied to the data lines DL11 to DL6K will be indicated as “ODD data driving signal” when the first gate driver 160 drives the first gate line group GL1 to GLn−1.

When the second gate driver 170 drives the second gate line group GL2 to GLn, the timing controller 132 controls and outputs the data signal DATA1 to DATA6 such that a gray scale voltage level of the data driving signal applied to the data driving circuit 141 placed far away from the second gate driver 170 becomes higher than that of the data driving signal applied to the data driving circuit 146 placed adjacent to the second gate driver 170 with respect to the same image RGB signals.

In FIG. 12, the data driving signal applied to the data lines DL11 to DL6K will be indicated as “EVEN data driving signal” when the second gate driver 170 drives the second gate line group GL2 to GLn.

The timing controller 132 applies the data signals DATA1 to DATA6 obtained by compensating for the image RGB signals to the data driving circuits 141 to 146, respectively. When the first gate driver 160 drives the first gate line group GL1 to GLn−1, the timing controller 132 increases the compensation amount of the data signals DATA3 and DATA6 applied to the data driving circuits 143 and 146 more than that of the data signal DATA1 applied to the data driving circuit 141 with respect to the image RGB signals. Thus, the brightness is not lowered in a position far away from the first gate driver 160 of the display panel 110.

Similarly, when the second gate driver 170 drives the second gate line group GL2 to GLn, the timing controller 132 increases the compensation amount of the data signals DATA3 and DATA1 applied to the data driving circuits 143 and 141 more than that of the data signal DATA6 applied to the data driving circuit 146 with respect to the image RGB signals. Accordingly, the brightness is not lowered in a position far away from the second gate driver 170 of the display panel 110.

As described with reference to FIG. 7, when the first gate driver 160 drives the first gate line group GL1 to GLn−1, the timing controller 132 delays the output timings of the data signals DATA1 to DATA6 respectively applied to the data driving circuits 141 to 146 on the basis of the distance in the first direction X1 between the first gate driver 160 and the data driving circuits 141 to 146. In addition, the timing controller 132 increases the compensation amount of the data signals DATA1 to DATA6 in accordance with the distance in the first direction X1 between the first gate driver 160 and the data driving circuits 141 to 146.

As described with reference to FIG. 8, when the second gate driver 170 drives the second gate line group GL2 to GLn, the timing controller 132 delays the output timings of the data signals DATA6 to DATA1 respectively applied to the data driving circuits 146 to 141 on the basis of the distance in the second direction X2 between the second gate driver 170 and the data driving circuits 146 to 141. In addition, the timing controller 132 increases the compensation amount of the data signals DATA6 to DATA1 in accordance with the distance in the second direction X2 between the second gate driver 170 and the data driving circuits 146 to 141.

That is, the timing controller 132 may perform one or both of the brightness compensation method using the output timing delay shown in FIGS. 7 and 8 or the brightness compensation method using the gray scale compensation method shown in FIG. 12.

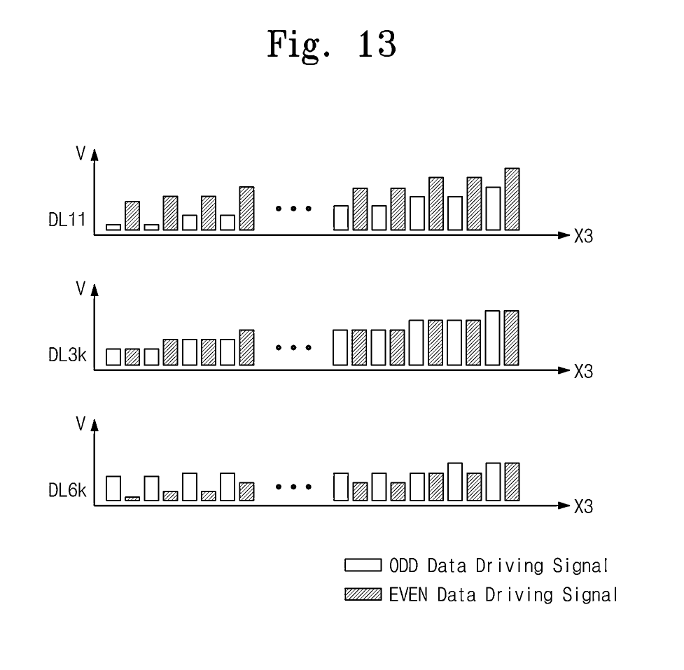

FIG. 13 is a view showing another example of compensating the data driving signals applied to the display panel shown in FIG. 1.

Similar to the brightness compensation method shown in FIG. 12, the brightness compensation method shown in FIG. 13 changes the compensation amount related to the data signals DATA1 to DATA6 in accordance with the distance in the first direction X1 between the first gate driver 160 and the data driving circuits 141 to 146 and the distance in the second direction X2 between the second gate driver 170 and the data signals DATA1 to DATA6.

Referring to FIGS. 2 and 13, the timing controller 132 increases the compensation amount of the data signals DATA1 to DATA6 on the basis of the distance in the third direction X3 between the data driving circuits 141 to 146 and the pixels PX.

In FIG. 13, the data driving signals applied to the data lines DL11 to DL6K is indicated as “ODD data driving signal” while the first gate driver 160 drives the first gate line group GL1 to GLn−1. In addition, the data driving signal applied to the data lines DL11 to DL6K is indicated as “EVEN data driving signal” while the second gate driver 170 drives the second gate line group GL2 to GLn.

The timing controller 132 controls and outputs the data signals DATA1 to DATA6 such that a gray scale voltage level of the data driving signal applied to the pixels PX placed relatively far from the data driving circuits 141 to 146 in the third direction X3 becomes higher than a gray scale voltage level of the data driving signal applied to the pixels PX formed adjacent to the data driving circuits 141 to 146 in the third direction X3.

The data driving signals output from the data driving circuits 141 to 146 are applied to the pixels PX of the display panel 110 through the data lines DL11 to DL6K. The data driving signals are delayed according to the distance in the third direction X3 between the data driving circuits 141 to 146 and the pixels PX. Since the compensation amount with respect to the data signals DATA1 to DATA6 is changed according to the distance in the third direction X3 between the data driving circuits 141 to 146 and the pixels PX, the brightness may be compensated at a position far away from the data driving circuits 141 to 146.

That is, the timing controller 132 may perform one or both of the brightness compensation methods using the output timing delay shown in FIGS. 7 and 8 or the brightness compensation method using the gray scale compensation shown in FIG. 13.

Although exemplary embodiments of the present invention have been described, it is understood that the present invention should not be limited to these exemplary embodiments but various changes and modifications can be made by one of ordinary skilled in the art within the spirit and scope of the present invention as hereinafter claimed.

What is claimed is:

1. A display device comprising:
a first gate driver;
a second gate driver;
a plurality of first gate lines extending in a first direction from the first gate driver;
a plurality of second gate lines extending in a second direction from the second gate driver;
a plurality of data lines extending in a third direction substantially perpendicular to the first and second directions;
a display panel including a plurality of pixels electrically connected to the first and second gate lines and the data lines;
a plurality of data driving circuits each configured to drive corresponding data lines among the data lines in response to an output start signal and a data signal; and
a timing controller configured to apply the output start signal and the data signal to the data driving circuits and control the first and second gate drivers, wherein the timing controller is further configured to set a first output timing of the data signal applied to each of the data driving circuits in accordance with a distance in the first direction between the first gate driver and the data driving circuits when the first gate lines are driven and to set a second output timing of the data signal applied to each of the data driving circuits in accordance with a distance in the second direction between the second gate driver and the data driving circuits when the second gate lines are driven.

2. The display device of claim 1, wherein the timing controller is further configured to increase a delay time of the first output timing of the data signal applied to each of the data driving circuits as the distance in the first direction between the first gate driver and the data driving circuits becomes longer when the first gate lines are driven.

3. The display device of claim 1, wherein the timing controller is further configured to increase a delay time of the second output timing of the data signal applied to each of the data driving circuits as the distance in the second direction between the second gate driver and the data driving circuits becomes longer when the second gate lines are driven.

4. The display device of claim 3, wherein the first direction and the second direction are opposite to each other.

5. The display device of claim 4, wherein the data lines are grouped into a plurality of data lines groups and the data driving circuits correspond to the data line groups.

6. The display device of claim 5, wherein the first gate driver is configured to sequentially apply first gate signals to the first gate lines and the second gate driver is configured to sequentially apply second gate signals to the second gate lines.

7. The display device of claim 6, wherein the timing controller is further configured to delay the first output timing of the data signal applied to each of the data driving circuits sequentially in the first direction by a time corresponding to the delay time in the first direction of the first gate signals applied to the first gate lines.

8. The display device of claim 6, wherein the timing controller is further configured to delay the second output timing of the data signal applied to each of the data driving circuits sequentially in the second direction by a time corresponding to the delay time in the second direction of the second gate signals applied to the second gate lines.

9. The display device of claim 5, wherein the timing controller is further configured to compensate for the data signal when the first gate lines are driven; wherein the data signal compensation is in accordance with a distance in the first direction between the first gate driver and a position of the display panel at which the data signal is displayed.

10. The display device of claim 9, wherein the timing controller is further configured to compensate for the data signal when the second gate lines are driven, and wherein the data signal compensation is in accordance with a distance in the second direction between the second gate driver and a position of the display panel at which the data signal is displayed.

11. The display device of claim 5, wherein the timing controller is further configured to compensate for the data signal in accordance with a distance in the third direction between the data driving circuits and a position of the display panel at which the data signal is displayed.

12. The display device of claim 11, wherein the timing controller is further configured to increase a compensation amount of the data signal as the distance in the third direction between the data driving circuits and a position of the display panel at which the data signal is displayed, increases.

13. The display device of claim 1, wherein the first gate driver is placed adjacent to a first end of the display panel and the second gate driver is placed adjacent to a second end of the display panel.

14. The display device of claim 13, wherein the data driving circuits are sequentially arranged in the first direction to be adjacent to a long side of the display panel.

15. The display device of claim 13, wherein the first gate lines and the second gate lines are alternately arranged one by one.

16. A display device comprising:
a first gate driver;
a plurality of first gate lines extending in a first direction from the first gate driver;
a plurality of data lines extending in a third direction substantially perpendicular to the first direction;
a display panel including a plurality of pixels electrically connected to the first gate lines and the data lines;
a plurality of data driving circuits each configured to drive corresponding data lines among the data lines in response to an output start signal and a data signal; and
a timing controller configured to apply the output start signal and the data signal to the data driving circuits and control the first gate drivers, wherein the timing controller is further configured to set a first output timing of the data signal applied to each of the data driving circuits in accordance with a distance in the first direction between the first gate driver and the data driving circuits when the first gate lines are driven.
